(19) United States
(12) Patent Application Publication
(10) Pub. No.: US 2011/0159470 A1
(43) Pub. Date: Jun. 30, 2011

(54) INTERACTIVE MEDICAL DIAGNOSTICS TRAINING SYSTEM

(76) Inventors: Thomas Hradek, East Northport, NY (US); Richard Hradek, Albertson, NY (US)

(21) Appl. No.: 12/647,079

(22) Filed: Dec. 24, 2009

(51) Int. Cl. G09B 23/28

(52) U.S. Cl. 434/262

(57) ABSTRACT

A medical diagnostics training system presents a sequence of interactive display images comprising a medical diagnostics case study (CS) to a student which includes challenges to which the student responds to qualify his/her competency in a diagnostics technique to be imparted by the case study (CS), collecting and processing the student responses to determine the competency in the diagnostics technique and providing a review of the response, and based thereon further providing directed feedback from a physician in the critical thinking in order to master the diagnostics technique where necessary. The system includes a computer processor for implementing system communication processes, interactive users interface processes, training workflow processes and medical diagnostics case study (CS) configuring processes and a database for receiving and storing data comprising the medical diagnostics case study (CS) and challenges, interactive display image data comprising and data comprising student responses to the challenges.

### BACKGROUND OF THE INVENTION

The present invention broadly relates to training of medical personnel and, more particularly relates to a computer-based interactive medical diagnostics training system pre-configurable to provide training to students to teach them to identify critical pathways for correctly diagnosing medical maladies via a user's interface presented by the system and student interactions are monitored to qualify his/her progress in learning/mastering the material and techniques and providing feedback based on the monitoring, which may include real-time feedback from physicians.

Computer systems that provide medical or health-related information are known. Also, interactive computer systems that provide interactive training of medical personal for carrying out medical procedures are known.

For example, U.S. Pat. No. 4,360,345 to Hon discloses a system and method a method of computerized instruction and testing to train individuals to perform predetermined functions on a peripheral, e.g., a mannequin. Hon stores instructions relating to the correct performance of the medical function, stores video and associated audio signals relating to the correct performance, displays instructions and video signals in conjunction with audio signals on a first display while a user manually performs the medical function on the peripheral according to the instructions. Upon detecting any incorrect performance, the system displays appropriate instructions and video signals in conjunction with the audio signals to illustrate the correct manner of performing the medical function on a second display. Hon indicates that a need for an actual instructor and/or live-instruction is eliminated using his system and method.

U.S. Pat. No. 4,907,973 to Hon discloses an expert system simulator for modeling used for training personnel in the medical and related arts. Users interact with the Hon expert system by physically manipulating a model (i.e., mannequin with sensors) to input information used by the system. The system is touted to establish realistic simulations of surgical and therapeutic procedures. The system is asserted to display simulated internal conditions that appear life-like, including monitor data, for example, blood pressure, respiration, heart beat rate and the like. The information displayed as the user interacts with the mannequin may be derived from video imaging, angiograms, magnetic resonance images, digitized x-rays and other visualizing methods.

U.S. Pat. No. 4,839,822 to Dormond, et al., discloses an expert system which provides one or more suggested treatments for a patient afflicted with physical trauma. The expert system includes a computing device having a memory, a plurality of data bases in the memory, an application program and an inference engine program. The data bases include graphical illustrations of different types of physical trauma, and a knowledge base with treatment information. The application program interactively displays a series of screens including at least some of the graphical illustrations, to elicit responses from the user concerning the specific types of physical trauma and specific characteristics of the patient. The inference engine program uses the knowledge base and information related to the responses elicited from the user to select one or more suggested treatments and the application program presents the suggested treatments to the user.

U.S. Pat. No. 6,126,450 to Mukai, et al., discloses medical simulator system in which a physical model such as a medical phantom or mannequin is not required to execute a simulated medical treatment. The medical simulator system includes storage means for storing virtual model information and medical information relating to at least a portion of a human body. The medical information is directed to a medical treatment selected from an operation, an examination or an experiment. A simulated medical instrument is generated by simulating a medical instrument used in the medical treatment. Control means controls a condition of a simulated medical treatment virtually executed by the operator and notifying means notifies information acquired by the control means to the operator.

None of the above mentioned systems and methods, however, disclose on-line teaching of medical diagnostics including interacting with the user to improve and hone their critical thinking skills as they interactively respond to various simulated medical/patient conditions presented, and further including grading or qualifying the user's responses and providing feedback by medical teaching professionals connected to the user through the system based on an assessment of the user test responses.

### SUMMARY OF THE INVENTION

The present invention provides an interactive medical diagnostics training system that overcomes the known shortcomings of conventional medical training system and methods.

In one embodiment, the interactive medical diagnostics training system provides a medical diagnostics training system that presents a sequence of interactive display images comprising a medical diagnostics case study (CS), which may include simulations, to a student which includes challenges to which the student responds to qualify his/her competency in a diagnostics technique to be imparted by the case study (CS), collecting and processing the student responses to determine the competency in the technique and providing directed feedback from a physician in the technique where necessary to improve the student competency in the critical thinking necessary to master the diagnostics techniques to be imparted by a particular case study. The feedback may be from one or any number of physicians, and may be provided in real time in a session where the student is able to query the physician to better define the critical thinking for mastering the diagnostics technique.

The interactive medical diagnostics system includes a computer processor for implementing system communication processes, interactive users interface processes, training workflow processes and medical diagnostics case study (CS) configuring processes and a database for receiving and storing data comprising the medical diagnostics case study (CS), test data, simulation data, and challenges, interactive display image data comprising and data comprising student responses to the challenges.

The medical diagnostics training system preferably includes that the communication processes control electronic communications with a student data processing system and that the computer processor comprises a server, wherein the student data processing system comprises a browser and wherein the communication processes implement and control the communication processes over a network using HTML and CGI protocol. Preferably, the communication processes further control electronic communications and messaging exchanges between the student and physician where necessary, and any sessions implemented with standard protocols.

The medical diagnostics training system provides that the interactive users interface processes cooperate with the communication processes to present the interactive display images comprising the medical diagnostics case study (CS) including simulations and challenge data and to collect and transfer student responses to the challenge data to the computer processor and/or the database, and to process and review the response in order to generate and direct feedback to hone the critical thinking in accordance therewith. The training workflow processes control a workflow for controlling the interactive users interface processes and the communication processes.

The case study (CS) configuring processes cooperate with the communication processes to receive data for configuring the system, including data for defining and controlling the training workflow processes and a rules engine is includes such that the medical diagnostics case study (CS) configuring processes define rules for the rules engine and wherein the rules engine controls the training workflow processes.

Key functionality of this system and application program is its character as an interactive tool to increase efficiency and retention of the medical diagnostics techniques by participating students, but perhaps more importantly, to hone the critical thinking that is necessary for the student to apply the diagnostics technique when confronted with facts and circumstances related to different than those presented in the case study (CS). Such method for learning recreates the experience of an ailing patient being presented to the student for diagnosis and with the response and feedback in response therefore develops in the student the diagnostics techniques for responding to acute medical needs of real patients, particularly under emergent circumstances.

By presenting a medical case study (CS) to the student via a computer application, the system begins to more closely simulate the pressures and thought processes required to effectively respond in an actual, interactive environment. Case studies (CS) are designed by physicians and medical experts. The entry or configuration of a CS within the interactive medical diagnostics training system is readily implemented by non-medical personnel.

### BRIEF DESCRIPTION OF THE DRAWING FIGURES

Aspects of the invention will become apparent upon reading the following detailed description and upon reference to the accompanying drawings in which, like references may indicate similar elements:

FIG. 1 is a system level diagram depicting a user connected to the interactive medical diagnostics training system via a Network;

FIG. 2 is a system level diagram depicting a user connected to an alternative interactive medical diagnostics training system, via the Internet;

FIG. 3 is a computer system within which an application program may be provided to carry out the functional operation of the medical diagnostics training system;

FIG. 4 is a block diagram representing the functional operation of the medical diagnostics training system;

FIG. 5 depicts a home page functionality of the medical diagnostics training system;

FIG. 6 depicts an exemplary student account request display image of the medical diagnostics training system;

FIG. 7 depicts an exemplary student home page functionality of the medical diagnostics training system;

FIG. 8 depicts an exemplary bulletin board display image of the medical diagnostics training system;

FIG. 9 depicts an exemplary “Tip of the Day” display image of the medical diagnostics training system;

FIG. 10 depicts and exemplary case study (CS) browse display image of the medical diagnostics training system;

FIG. 11 depicts a physician home page functionality of the medical diagnostics training system;

FIG. 12 depicts an exemplary Administrative “Students” display image of the medical diagnostics training system;

FIG. 13 depicts and exemplary Administrative “Assign CS to Students” display image of the medical diagnostics training system;

FIG. 14 depicts and exemplary Administrative “news” display image of the medical diagnostics training system;

FIG. 15 depicts an Administrative Home Page functionality of the medical diagnostics training system;

FIG. 16 depicts and exemplary Administrative “Create Physicians” display image of the medical diagnostics training system;

FIG. 17 depicts and exemplary Administrative “Administration Tip of the Day” display image of the medical diagnostics training system;

FIG. 18 depicts and exemplary Administrative “Administration Promotion Area” display image of the medical diagnostics training system;

FIG. 19 depicts the test score functionality of the medical diagnostics training system;

FIG. 20 depicts an exemplary Administrative “Introduction/History” display image of the medical diagnostics training system;

FIG. 21 depicts and exemplary Administrative “Diagnoses” display image of the medical diagnostics training system;

FIG. 22 depicts a functional flow for students of the medical diagnostics training system;

FIG. 23 depicts a CS functional flow of the medical diagnostics' aining system;

FIGS. 24A and 24B depict a test library and a diagnoses library of the medical diagnostics training system;

FIG. 25 depicts the account management functional flow of the medical diagnostics training system;

FIG. 26 depicts a User Groups/Privileges/Departments functional flow of the medical diagnostics training system;

FIG. 27 depicts and online testing certification functional flow of the medical diagnostics training system.

### DETAILED DESCRIPTION OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention, as defined by the appended claims. The descriptions below are designed to make such embodiments obvious to a person of ordinary skill in the art.

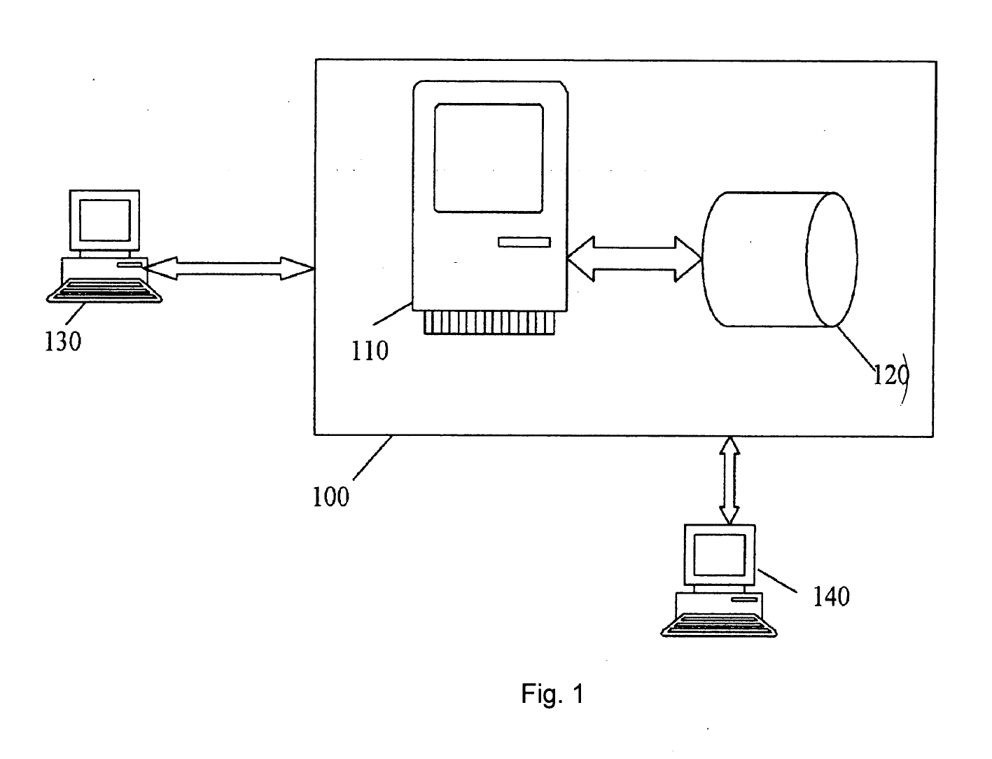

Turning now to FIG. 1, one embodiment of a medical diagnostics training system (100) will be described. Medical diagnostics training system (100) comprises a general purpose computer, data processor, computer server, etc., configured to present sequences of interactive display images comprising a medical diagnostics case study (CS) to a student, and thereafter and/or concurrently, to collect and process student responses. The medical diagnostics case study (CS) comprises a simulation of a real patient with a medical issue or malady. The medical diagnostics case study (CS) may serve various treatment circumstances. For example, a case study (CS) may simulate a patient entering a doctor's office, a hospital emergency room, etc., with a particular set of symptoms, where based on the location certain treatment tools and devices are available.

As shown in FIG. 1, the system includes the built in logical functions necessary to correctly organize the data into the meaningful structure for operating the users interface, i.e., a rules engine. The medical diagnostics case study (CS) includes and presents challenges to which the student responds to determine his/her competency in a diagnostics technique to be imparted by the case study (CS), and the critical thinking necessary to master the diagnostics technique.

That is, as the sequence or sequences of images are presented, certain of the images present challenges to the student to test their competency in the instant medical diagnostics case study (CS) material, or in material previously presented during a long term course of training. The student responds and enters data in response to the challenges. The challenges, along with other pertinent data input by the student, are collected in a format that is conducive to real world experiences and learning. The system then qualifies the student's competency in learning the material or medical diagnostics technique presented. That is, the system implements an elaborate review process during and after the case study is conducted based on the student responses and interactive feedback, to qualify the student's competency in the necessary critical thinking for the diagnostics technique relating to the case study (CS).

Upon qualifying the student's competency in the medical diagnostics technique, critical thinking and/or broader course of training, the system provides directed feedback. The directed feedback may be in a form of further display images containing medical and training information, including attached writings, and may be in a form of feedback from a physician in the medical diagnostics technique where necessary to improve competency. That is, the system further provides for a mentor, i.e., physician, to monitor the student's progress, which mentor may communicate directly to the student in a live or real-time session.

Medical diagnostics training system (100) comprises a computer processor (110) for implementing system communication processes, interactive users interface processes, training workflow processes and case study (CS) configuring processes. Computer processor (110) is connected to a database (120). Database (120) is configured for receiving and storing data comprising the medical diagnostic case study (CS) and challenges (documents and text), interactive display image data comprising and data comprising student responses to the challenges. Preferably, the system includes an application program downloaded to and operational on the general purpose computer, data processor, computer server, etc., to implement the presentation of the sequence of interactive display images comprising a medical diagnostics case study (CS) to a student and collect and process student responses.

A user/student computer system (130) is shown connected directly to medical diagnostics training system (100). While the user/student computer (130) is shown connected directly (e.g., Ethernet) to medical diagnostics training system (100), the invention is not limited to such arrangement. That is, the Medical diagnostics training system (100) may be connected or attached to a user/student computer (130) indirectly through an Intranet (Network) or through the Internet. A second computer system (140) is shown connected to medical diagnostics training system (100) represents a physician for providing feedback to a user/student in response to a need determined by the application program and/or computer processor (110).

The feedback is preferably presented immediately from the physician connected to the user/student computer system (130), i.e., in a real time live session. This enables the user/student to respond to the feedback with further questions, where necessary, to which the physician can be instantly responsive. While a user/student computer system and/or physician computer system may merely communicate with system (100) via each system's respective communication means, a session may include first downloading a portion of the inventive application program to each from the medical diagnostics training system (100), where same is processed locally by a microprocessor or like device thereat.

However, the feedback may be presented at some point after the processing and reviewing the student responses to the case study (SC) challenges, where the instructor may or may not connect to the user/student during a live session. But in addition, the system may provide further information by way of case study data including simulation where the system determines from the user/student responses that the student is in need. While this information may be stored in the database, at time the system or physician might determine that information that is known not to be stored in the system database would be helpful to the user/student, based on the rules-controlled operation.

Under such circumstances, the system may automatically search the Internet for same information, and present it to the user/student as part of the feedback. The feedback may be in any data form. For example, the feedback may be in a form of written communication messaging, i.e., email, or via direct connection communication program. Such communication program might enable VoIP or Webcam exchange, depending on the sophistication of the hardware and software comprising user/student computer system (130) and physician computer system (140).

Where the system or mentor determines that the student might be benefit from additional data relating to the instant medical diagnostics case study (CS), additional Material can be provided to the student in various additional display images, with attachments. For that matter, if either the mentor during the live session or the system itself determines that the student could benefit from additional instructive data not present in a system database or other accessible storage means, a search is implemented to identify additional training data to further support the student's online learning process, which is then presented to the student.

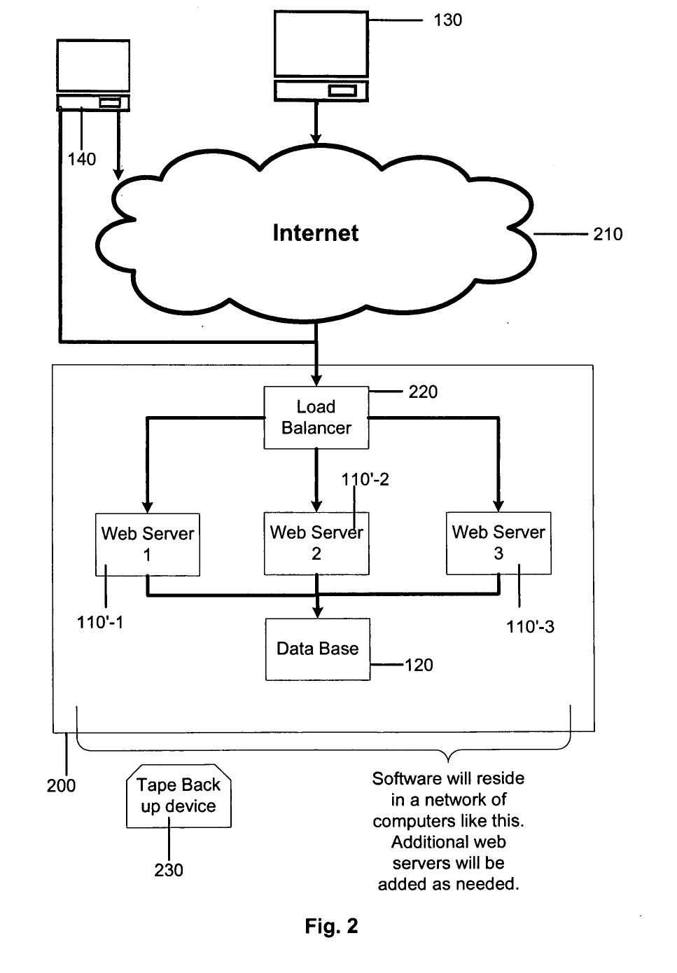

FIG. 2 herein presents a second embodiment of a medical diagnostics training system (200) of the invention. Medical diagnostics training system (200) differs from the FIG. 1 embodiment in view of the fact that it comprises a plurality of computer web servers (110′), i.e., (110′-1). (100′-2) and (100′-3). The application program may reside on one or on each of the computer web servers (110′), or on any one of the plurality of computer web servers (110′) or may be distributed about the plurality computer web servers. Database 120 is shown connected to each of the plurality of computer web servers (110′). In addition, a load balancer (220) is shown connected to the plurality of computer web servers (110′) in order to coordinate and balance traffic to the application program implementing the inventive medical diagnostics training system from user/student computer systems (e.g., computer system 130) and/or physician systems (e.g., physician computer system (140)).

The physician computer system (140) may be connected directly to the load balancer (220) of the medical diagnostics training system (200), or may be connected via Internet (210). The user/student computer system (130) is shown connected through Internet (210) to the medical diagnostics training system (200) through load balancer (220). It should be noted, however, that the network definition of FIG. 2 is depicted for exemplary purposes only, and not to limit the inventive system, and the functionality of the application program implemented thereby in any way in view of the claims appended hereto.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the method, and variations on the method as described herein. Alternatively, a specific use computer, containing specialized hardware for carrying out one or more of the functional tasks of the invention, could be utilized.

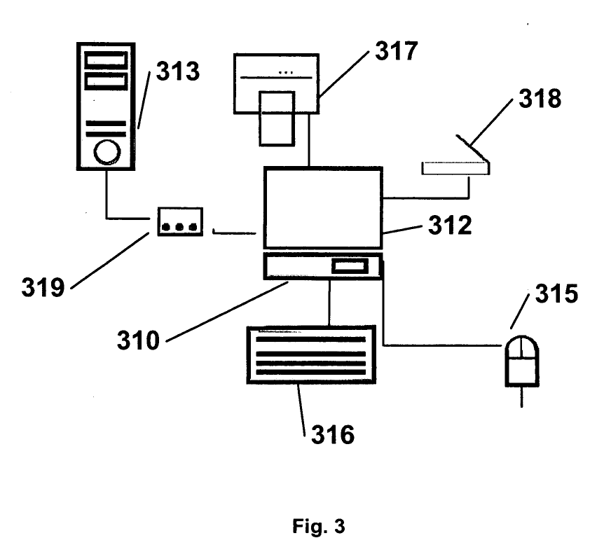

A computer-based system (300) is depicted in FIG. 3 herein, by which the inventive method or application program implemented by the medical diagnostics training system may be carried out. The computer-based system (300) includes a processing unit (310), which houses a processor, memory and other systems components (not shown expressly in the drawing figure) that implement a general purpose processing system, or computer that may execute a computer program product. The computer program product may comprise media, for example a compact storage medium such as a compact disc, which may be read by the processing unit (310) through a disc drive (312), or by any means known to the skilled artisan for providing the computer program product to the general purpose processing system for execution thereby.

The computer program product comprises all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit (310), as mentioned, or may be located on a remote system such as a server (313), coupled to processing unit (310), via a network interface such as an Ethernet interface. Monitor (314), mouse (315) and keyboard (316) are coupled to the processing unit (310), to provide user interaction. Scanner (318) and printer (317) are provided for document input and output. Printer (317) is shown coupled to the processing unit (310) via a network connection (319), but may be coupled directly to the processing unit. Scanner (318) is shown coupled to the processing unit (310) directly, but it should be understood that peripherals might be network coupled, or direct coupled without affecting the ability of the processing unit (310) to perform the method of the invention.

The novel medical diagnostics training system teaches the critical thinking necessary for a medical professional to make correct diagnosis for the correct reasons.

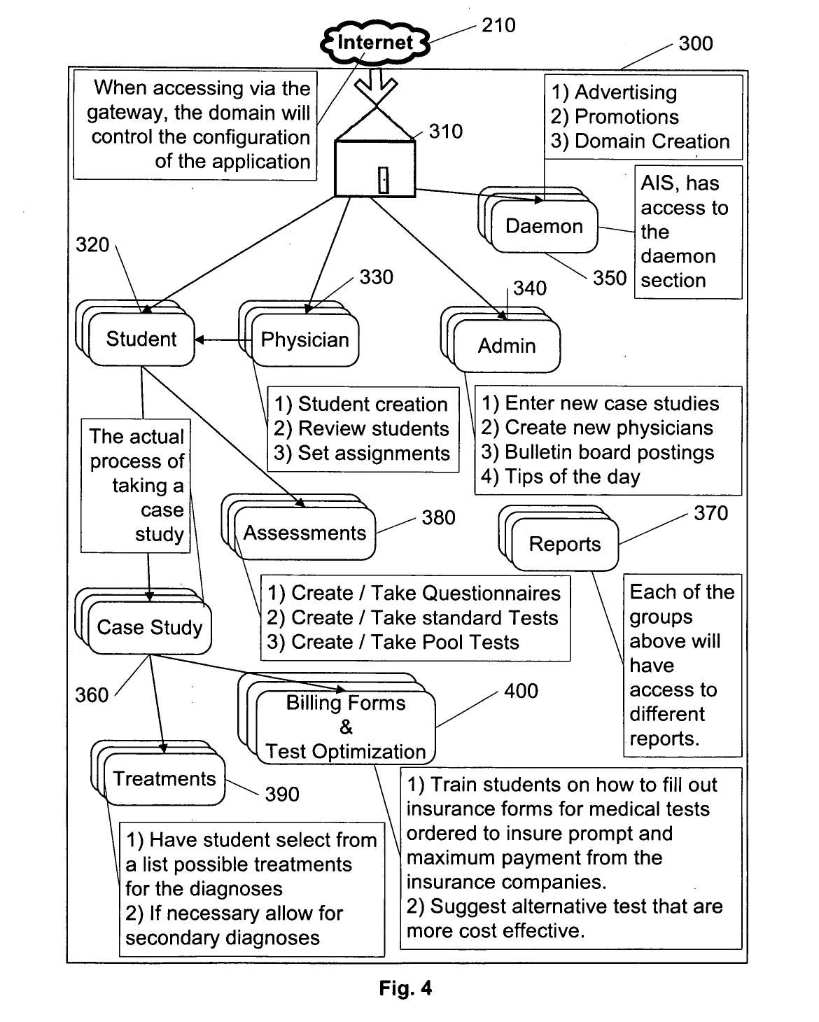

In an embodiment depicted in FIG. 4, an inventive medical diagnostics training system (300) includes a gateway (310), shown connected to Internet (210), and a number of different functional blocks, referred to interchangeably herein as functions or sections. Block (320) represents a student section and functionality; block (330) represents a physician section and functionality; block (340) represents an administrative section (referred to as Admin) and functionality; block (350) represents a Daemon section and functionality; block (360) represents a case study (CS) section and functionality; block (370) represents a Reports section and functionality; block (380) represents and Assessments section and functionality; block (390) represents a Treatments section and functionality; and block (400) represents a Billing Forms & Test Optimization section and functionality.

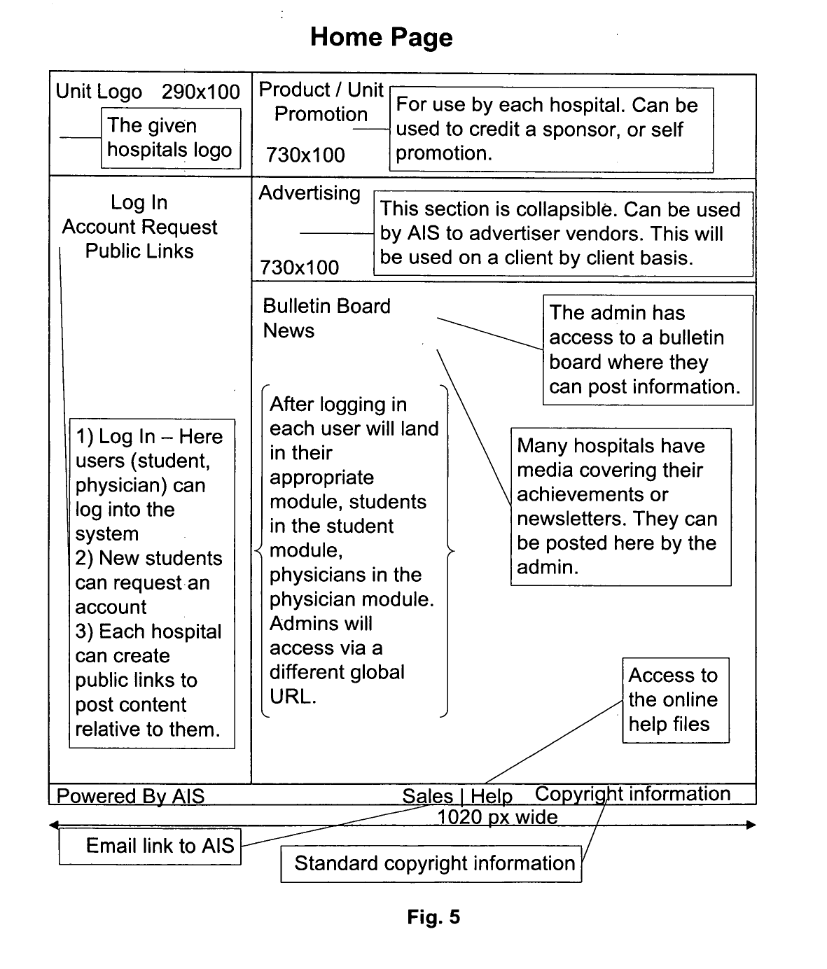

The medical diagnostics training system implements and presents a home page to all users, including students, administrators, physician/mentors, information technologists, etc., who enter the application through the home page (FIG. 5). The home page is therefore the hub of the application program, or system functionality. Each user has an ability to enter into the desired sections or functions depicted and accessible. Access to each section is controlled by privileges granted to the user.

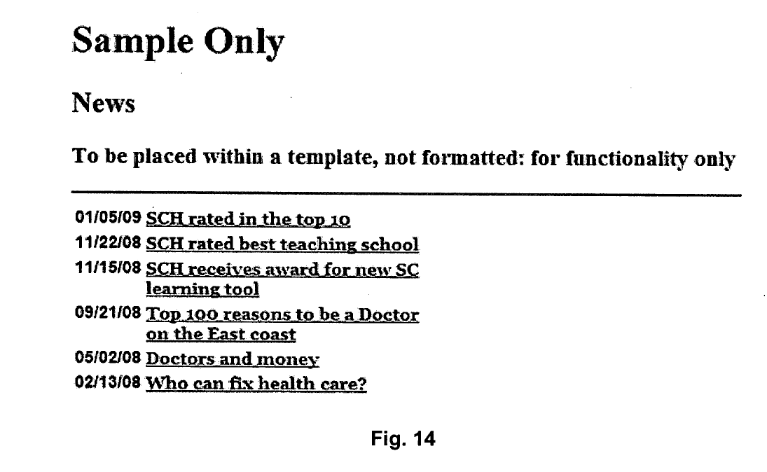

As shown in FIG. 5 embodiment, the home page contains the following elements:
1) A unit logo that the hospital can display, which may be hyperlinked.
2) A product/unit promotion comprising a standard size ad unit which can be used by the hospital to self promote or to promote a sponsor.
3) A navigation area, preferably presented on the left of the home page, will display available links, information about the user and additional information.
4) An optional advertising, the functionality of which may be activated optionally by system administrators. This section is a standard ad unit size and can be sold to outside vendors for additional revenue streams.
5) A content area comprising a majority of the home page display image area. While not limited to a specific arrangement, and of course modifiable by the system administrator, an exemplary content area might contain three main pieces of content:
   a. Bulletin Board: The hospital admin can post messages to its users.
b. News: The hospital admin can post news about the hospital, break throughs in medicine or any other relevant information. See FIG. 14 (news_display.html).
   c. Should the hospital choose not to use options a or b then static content can be placed here.
6) An optional footer is available. In an exemplary embodiment, the optional footer might contain 3 elements:
   a. On the left: “Designed By SCH Powered by AIS”
   b. Centered: a link to sales information and a link to help documents
   c. On the right: Copyright information about the application

In FIG. 5, the different elements are illustrated in a wire frame. The minimum width of the website display image is preferably 1020px wide, which is the industry standard. The width and height of the promotional units also should be industry standard. Each institutional user (hospital) will have a unique URL. The URL will determine which hospital the user is accessing.

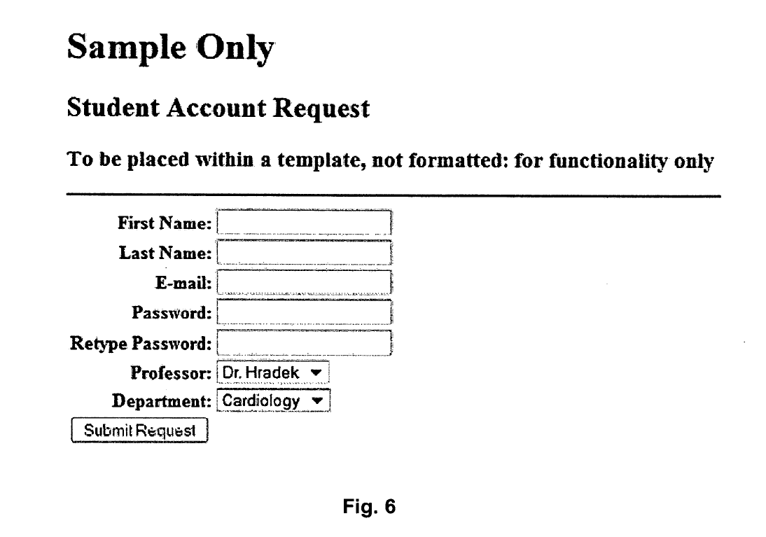

From the navigation area the user will have the following options. These options will be displayed in the content area.
1.) Log in: a log in prompt will be displayed to log in with a “forgot your password” option. Note: usernames will be email addressed.
2.) Account Request: an account request will allow a user to fill in information and request an account, as shown in FIG. 6. Once the account is requested a designated user will approve the account, see admin section for more information.
3.) Student Home: a home link will display the content area as described above.
4.) Public Link: each institutional user may wish to have additional pages which are open to the public.

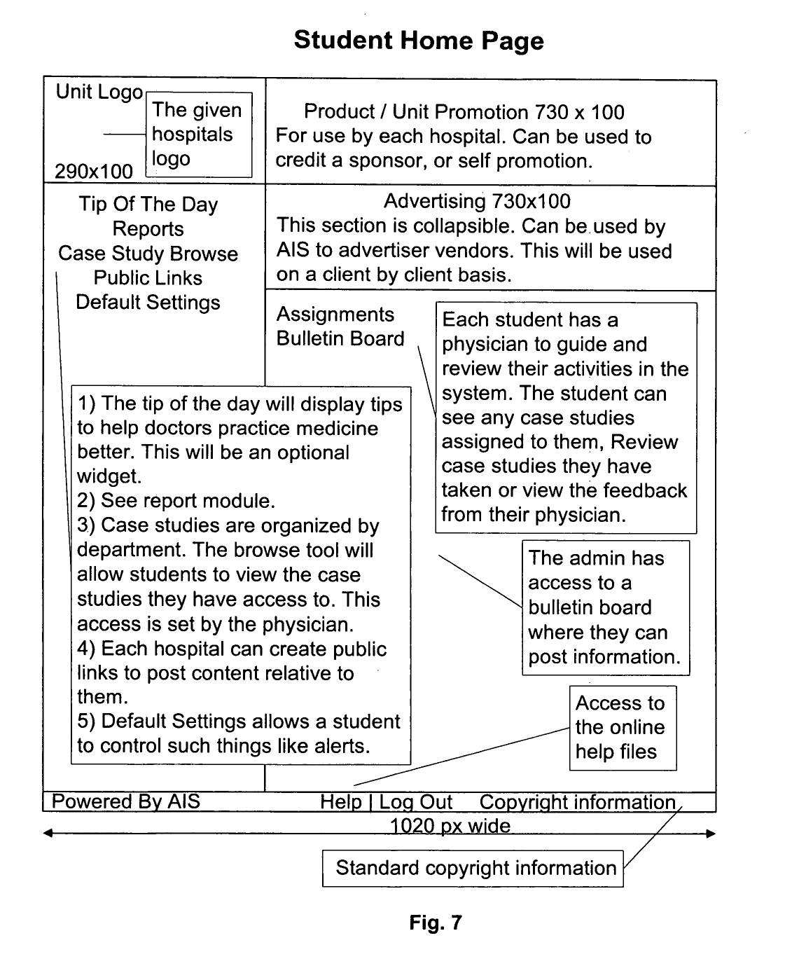

Student Section (320) allows for students to sign into the system to see new assignments, read through the bulletin boards and take medical case studies (CS), etc. Additional actions or secondary functions for the student may also be implemented. The student section is laid out much as is the home page, as shown in FIG. 7.

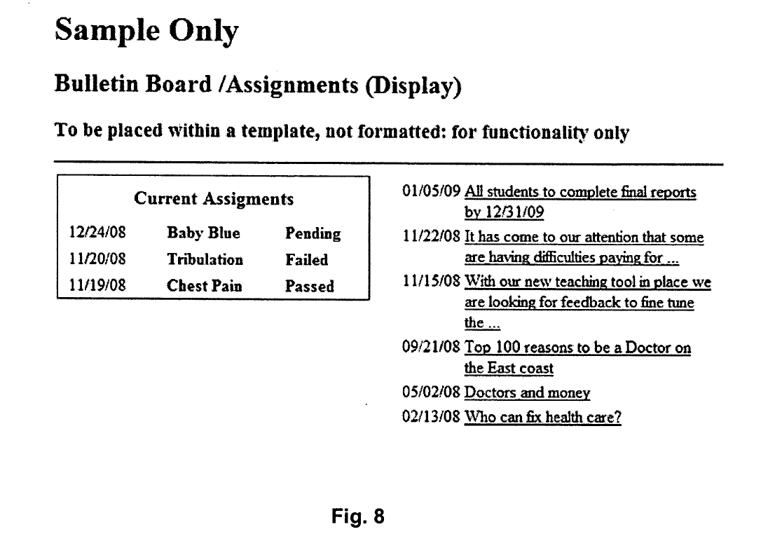

Content Area:
a. Assignments: Physicians will assign CS to students, as shown in FIG. 8. The display image will list the assigned CS, the due date and the status. Students will gain access to a bulletin board linked to that CS once they have completed it. The CS name may be colored to indicate difficulty level. By clicking on the CS name, the student is able to start the CS. The administrator can choose to use a single level but an option for additional levels exists.
b. Student Bulletin Board: Like the home page bulletin board, the physicians are to add content to the bulletin board, e.g., information from upcoming events to assignments.

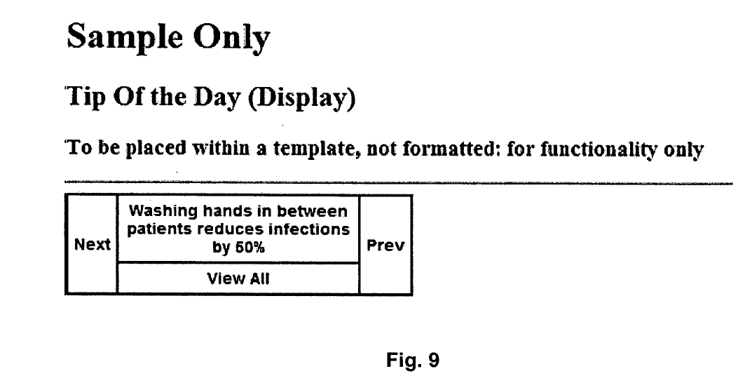

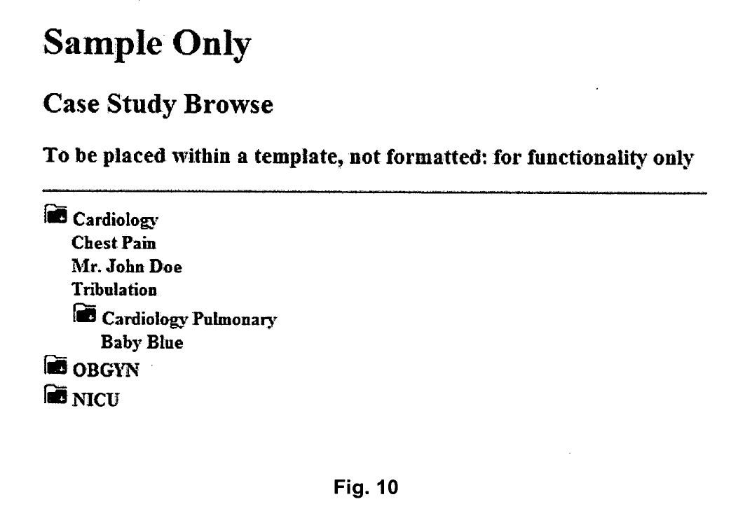

Navigation: from the navigation area the user has the following options:
a. Tip of The Day: The tip of the day will comprise a widget at the top of the navigation area. The widget should include text that is a few lines long to help convey important information to the training physicians. For example, it could provide medical tips such as “washing hands in between patients reduces infection by 50%” (FIG. 9). Below the tip are controls to allow users to advance or retreat to the next tip or download the complete list of tips. Tips are populated by controls in the physician section, see physician section for more information. This widget is optional.
b. Case study (CS) Browse: Students are able to browse through the CS they have access to. Access is granted by the physician. CS are grouped by departments, some departments may even have sub departments. By clicking on a department, the user will see all CS and sub departments. After the CS name other elements may be displayed such as a description. By clicking the CS name (for example, Cardiology Pulmonary), the student will be able to initiate it, as shown in FIG. 10.
c. Public Links are preferably the same as home page public links.
d. Private Bulletin Boards: private bulleting boards allow users to communicate with each other using this system. The primary purpose is to facilitate learning through communication between students and physicians.

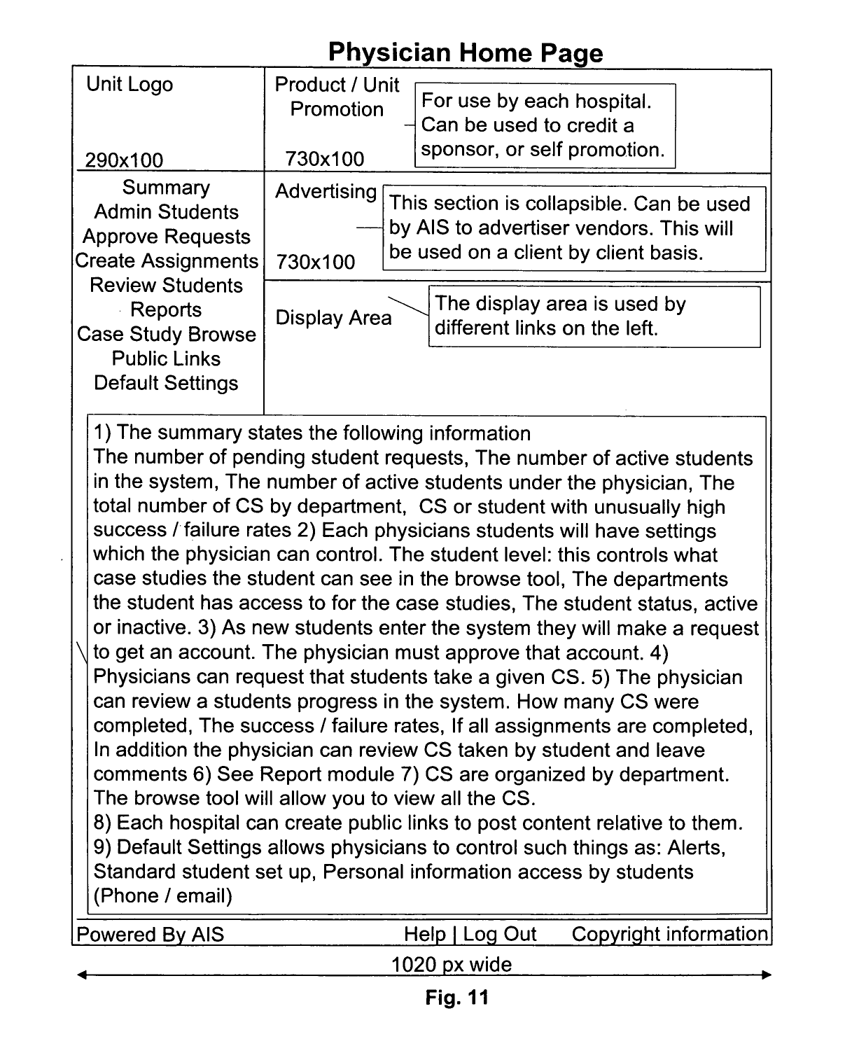

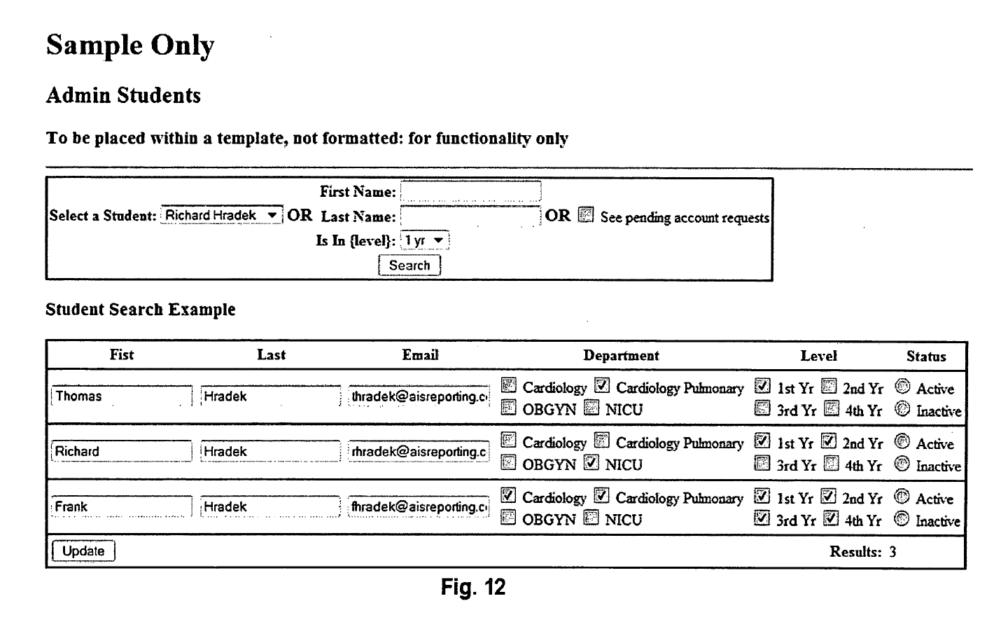

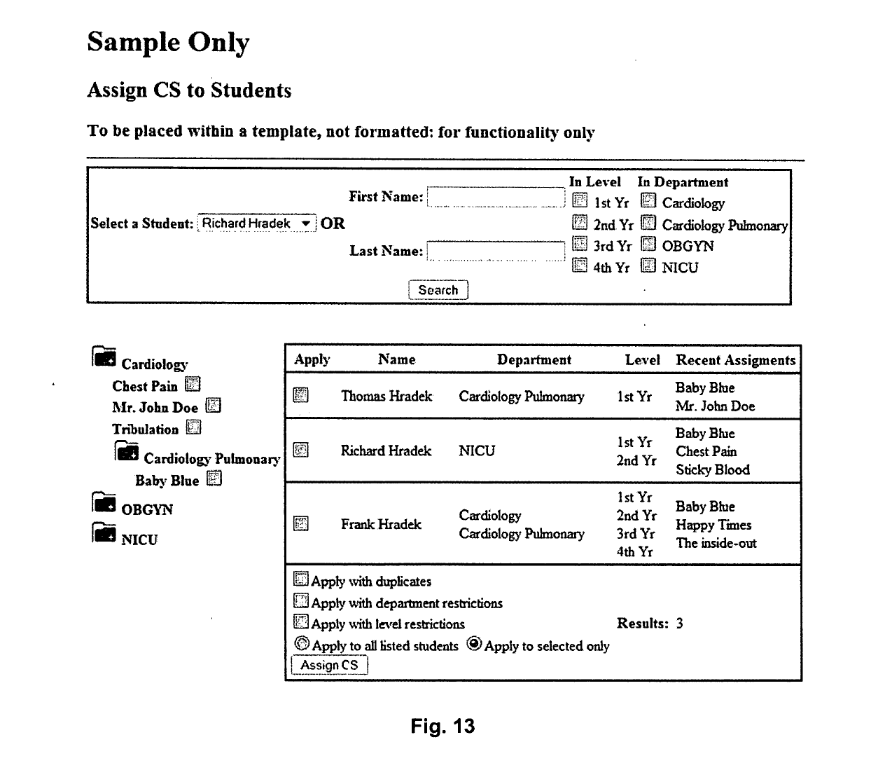

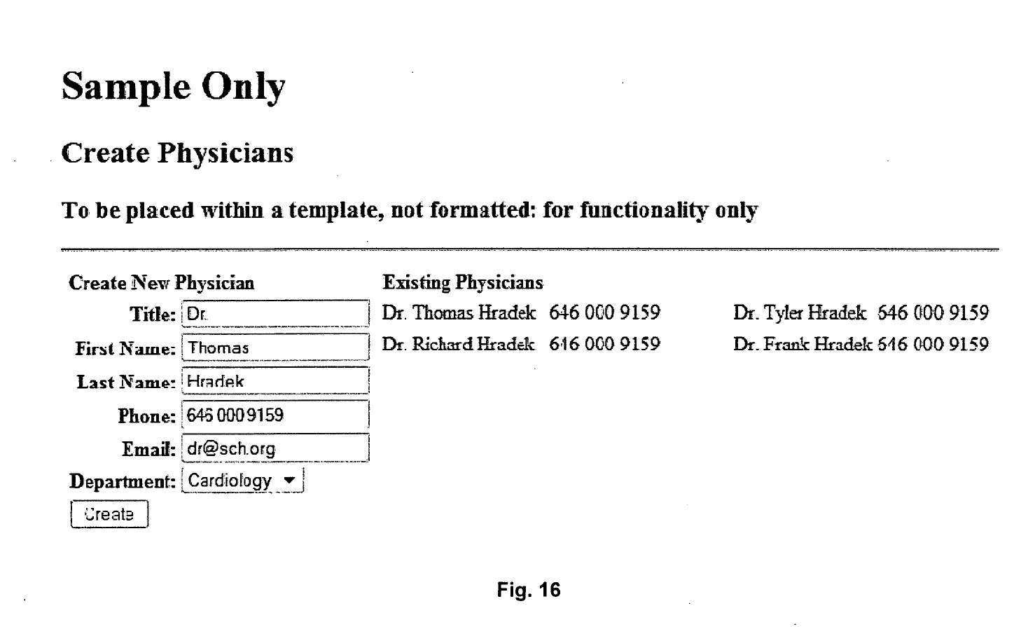

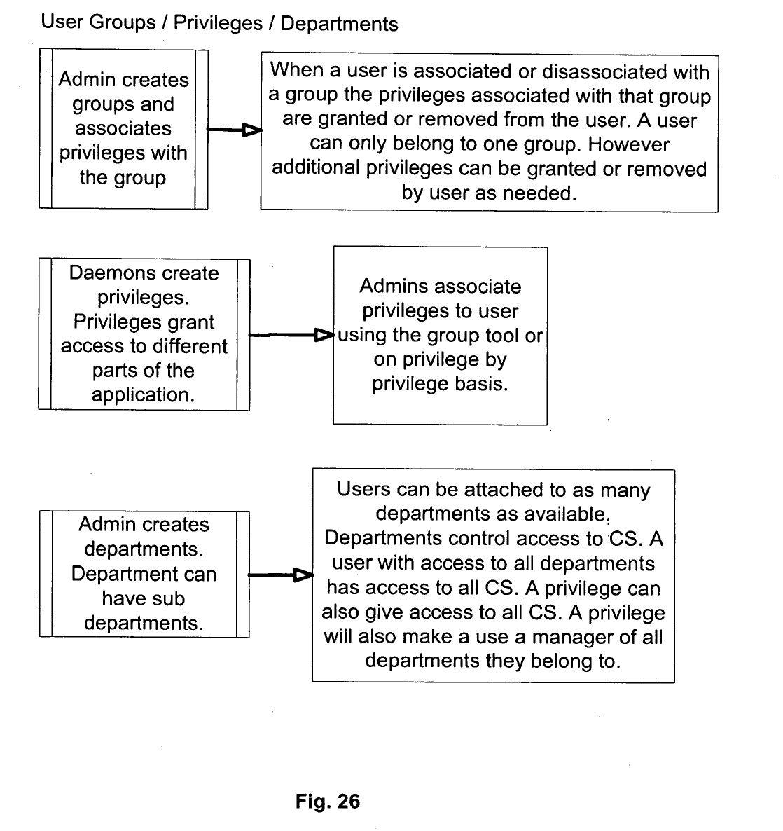

Physician Home Page section (330): Physicians or mentors have use of this section to assign CS, approve students and review CS taken by students if necessary. The physician section, as seen in FIG. 11, is laid out in much the same way that the student home page is. The following sections are:
1) Content area: the content area is populated by the links in the navigation area. The default content will be the summary information.
2) Navigation: from the navigation area the user will have the following options. These options will display in the content area unless noted.
   a. Summary: This link displays some summary information that may be useful to the physician, for example:
      i. A number of pending student requests;
      ii. A number of active students in the system;
      iii. A number of active students under the physician;
      iv. A number of CS by department;
      v. CS with unusually high success/failure rates;
      vi. Students with unusually high success/failure rates; and
      vii. A number of pending messages from students.
   b. Admin Students: Physicians have an ability to grant privileges to students, as can be understood by a careful review of “Admin Students” functional template of FIG. 12 and the “Assign CS to Students” functional template of FIG. 13. Privileges grant access to various portions of the web application, for example:
      i. CS level: The CS level controls what CS the student has access to. For example, a student may have an option of four levels of access, where each level coincides with the year of schooling the student is attending.
      ii. Student Department Access: This provides for control of departments that students have access to.
      iii. Student Status: This identifies whether a student is active, inactive or expired.
   c. Approve Requests: As new student's request accounts, the physician or another designated user, such as a system administrator or authorized information technologist must approve them, as should be clear from a careful review of FIG. 26.
   d. Create Assignments: Physicians can request that students take a CS, as shown in FIG. 16. When this assignment is made, a notice automatically appears in the student's assignment area. The physician can make assignments by student, department, both or all, as shown in FIG. 13. Once the students and CS are chosen, the physician can enter a message that will be entered into the student's private bulletin board. The same information is automatically sent to the student via email.
   e. Review Student(s): A physician may wish to review a CS taken by a student, or see an overview about the student's activities. The data available is:
      i. Number of CS completed;
      ii. The success/failure rates of the student;
      iii. If all assignments are completed;
      iv. Student profile;
   f. Case study (CS) Browse: the case study (CS) browse operates as does the corresponding entry in the student section. The Physician case study (CS) browse, however, includes an additional feature whereby physicians have complete access to all CS.
   g. Default Settings: The system includes configurable default settings to help physicians more efficient in their system use.
      i. Physician Email Access: If the physicians email should be displayed to students.
      ii. New Student Request Summary: An email can be sent each day with a summary of new summary requests. If there are no new requests no email is sent.
      iii. New Student Defaults: When a student requests an account, the physician has to set attributes of the student. In this function, default settings are assigned to speed up the approval process.
      iv. Physician Phone Access: If the physician's phone should be displayed to students.
      v. Private Bulletin Board Alerts: An email with a summary of the day's activities on the bulletin boards can be sent to the physician.
   h. Public Links: This section or function is the same as the corresponding entry in the student section.
   i. Reports: The system tracks many data points that may thereafter be “mined” from the system, some of which are used by the physician.

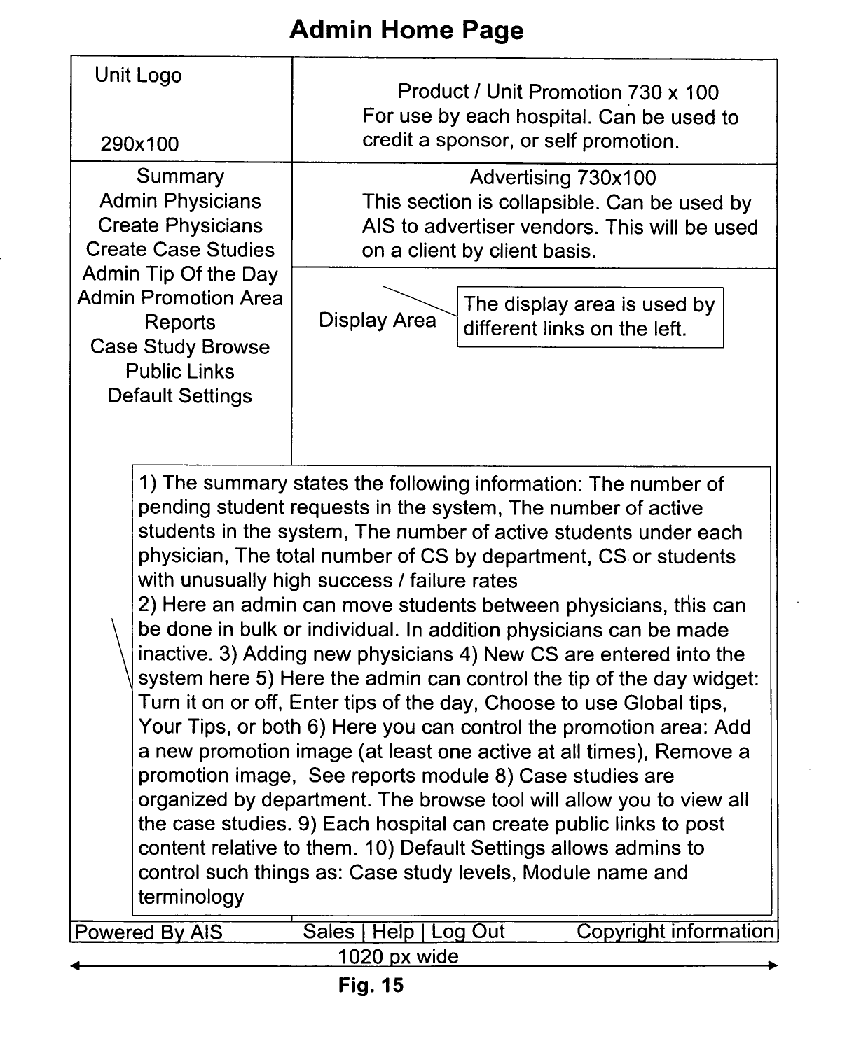

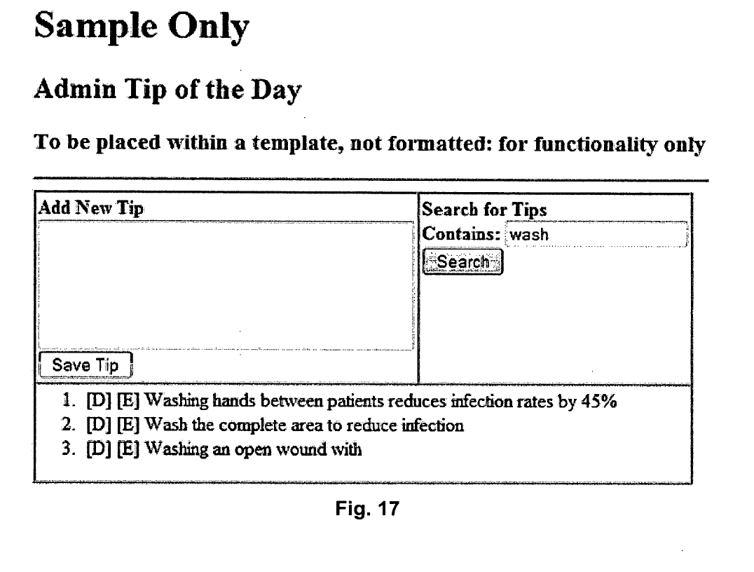

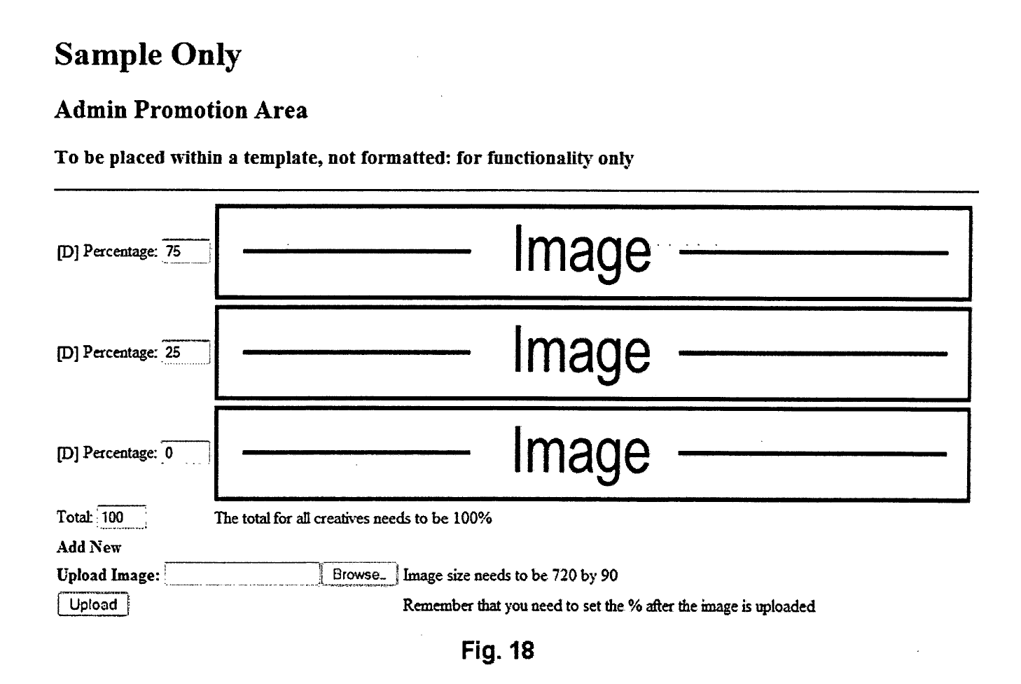

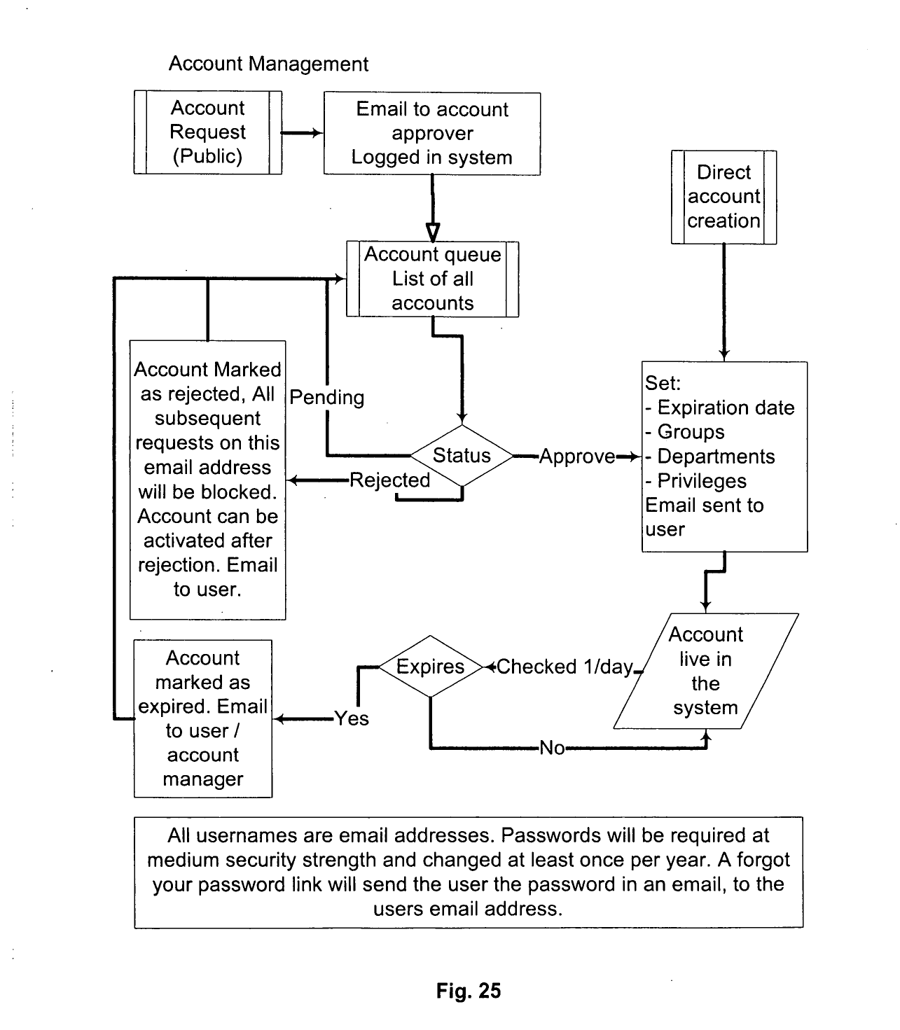

Admin Home Page Section (Admin 340): The system administrators set global controls for their institution, grant physicians access, create other administrators and other wise define the particular system configuration, as shown in FIG. 15. The administrator's work in configuring the system is most intensive prior to system operation, and once operation, is typically minimal. The Admin Section is configured similarly to that of the student home page (FIG. 7). The FIG. 15 Admin Section includes the following sections:
1) Display Area: The display area section is used to display the content from the navigation area. The display area defaults to the summary link.
2) Navigation: The navigation section presents a list of links to the different actions/tools.
   a. Summary: This link displays summary information:
      i. A number of pending student requests in the application;
      ii. A number of active students in the application;
      iii. A number of active students under each physician;
      iv. A total number of CS by department;
      v. CS with unusually high success/failure rates; and
      vi. Students with unusually high success/failure rates.
   b. User Admin: The administrator or other user can activate or inactivate users and/or update settings of existing users, as shown in the flow chart of FIG. 26.
   c. Create Users: This section allows the administrator or another designated user to create new users using this section (function), as should be clear by a careful review of FIG. 26. All users will be created with an expiration date for their access. Once this date is passed, the user will no longer be able to access the system. An email is automatically sent to the user alerting them to the change in status.
   d. User Groups: This section allows the administrator to create additional user groups and predefine a group's access within the system. Initial groups, for example, are Student, Physician and Admin, as can be seen by the functional flow of FIG. 26.
   e. Create CS: this section of function is explained in detail below.
   f. Administration Tip of The Day: This is shown in FIG. 17, in view of the fact that the administrator is able to perform several actions including:
      i. Toggle the widget on/off;
      ii. Enter in tips; and
      iii. Toggle between global tips, hospital tips, or both.
   g. Administration of the Promotion Area: This section or functions allows the administrator to upload an ad unit, for example, a 728×90 pixel ad unit comprising promotional content. The administrator can then set the rotation rate between the different units. This is useful for self promotion or sponsor promotion, as shown in FIG. 18.
   h. Case study (CS) Browse: This section functions similarly to that already described in the physician section.
   i. Default Settings: This section or function allows the administrator adjusts the system or application program attributes, essentially customizing it to the institution's needs. Examples include:
      i. Names of the levels and corresponding color of CS;
      ii. Departments;
      iii. Set CS category values;
      iv. Set CS category names;
      v. CS survey questions (see testing/certification section);
   j. Application Settings: This section or function displays the settings the institution implementing the system defines, that is the preconfigured rules definitions, such as:
      i. Advertising Unit display status;
      ii. Allowances in user usage;
   iii. Current user usage;
      iv. List of public links;
      v. Institution contact information;
      vi. Current storage usage; and
      vii. Current bandwidth usage.
   k. User Requests: The Admin can designate one or more users to approve student account requests, as can be seen in the Account Management functional flow of FIG. 25.
   l. Reports: may be of any useful kind.

Daemon Section (350): The daemon section is for the sole use of administrator, and typically comprises proprietary information relating to the institution in which the system is to be operated. The daemon section allows for the software administrators to manage the system as a whole.

The Daemon section provides a suite of tools or functions including at:
1) Help file management—Allows a user to edit/add/manage the help files
2) New Institution creation—This tool will take a user through the process of creating new institutions
3) Case Study Porting—This allows us to copy case studies from one institution to another
4) Billing Records—This is where all the billing records are kept

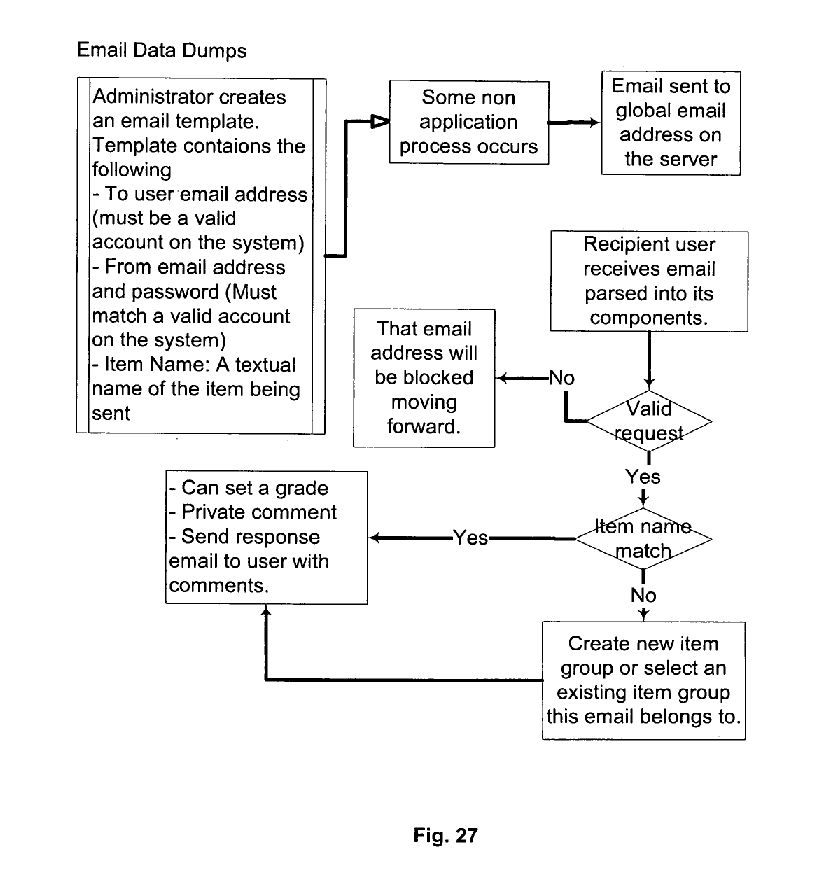

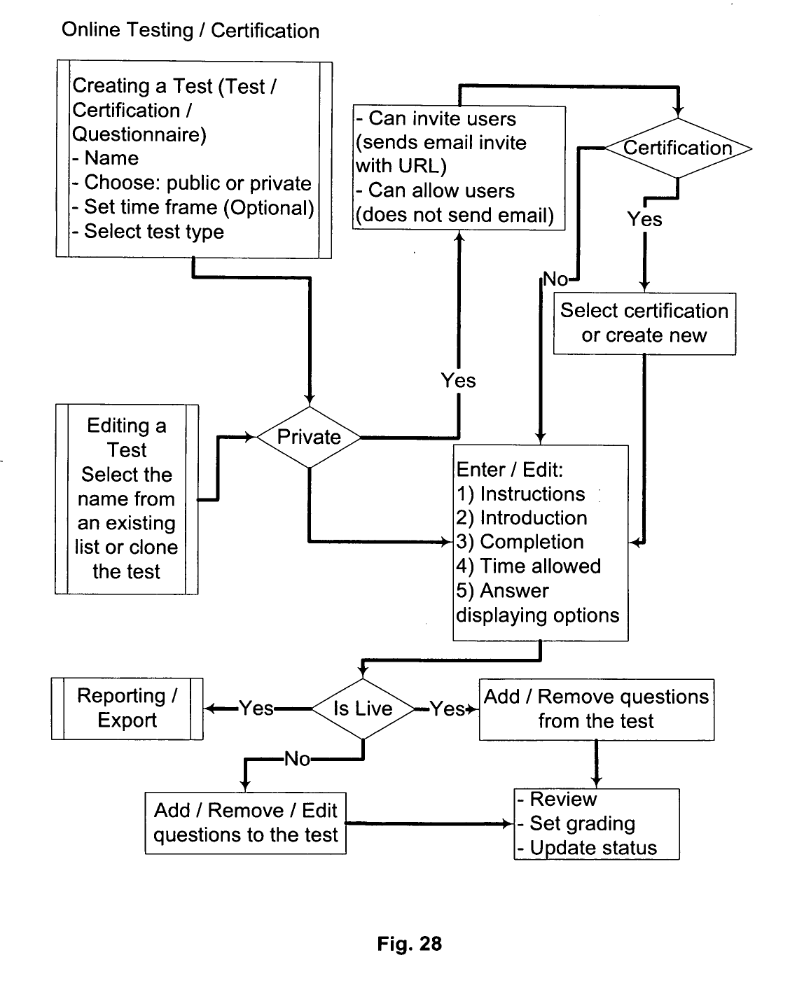

The system includes an ability to submit Online Testing/Questionnaires, essentially as a logical extension of the system application program more traditional online testing ability. The system administrator may use this functionality to leverage existing software whereby the institutional user, with proper privileges, can create tests or questionnaires, as can be seen from a review of the functional flow of FIG. 27. These tests will be stored in a library for reuse, and may be deployed in many ways. For example:
1) A test may be presented in a display image in response to a given system, for example, at a fixed point within or at the end of a CS.
2) A test may be presented in a display images as an invitation to a user or in display images as invitations to group of users. The test can be made available for a given time frame.
3) A test may be presented as a public offering to all users, for a given time frame, for example, by email delivery.
4) A test may be presented at a specific time for specific users.
   The different question types comprising tests include but are not limited to the following:
1) Single choice questions, with a random order option;
2) Multi-choice questions, with a random order option;
3) an ordered or prioritized list of questions;
4) questions that are ranking on a scale;
5) Text label questions;
6) Free text questions; and
7) Boolean (yes/no—true/false) questions

Scoring may be applied by the test creator or may be evenly distributed across all questions. Correct answers may be displayed to the test taker at the end of the test or not at all. Explanations of the correct answers may be entered into the test to be displayed at review time.

Reporting is a natural extension of the novel system and application program. General reporting on a given test is possible, and as mentioned above, so is data mining into a given test data set. A report concerning completion of a given test show what students were invited to take the test and whether they have completed it, as can be seen in FIG. 26.

Additionally a pool test can be created by a system administrator. The pool test comprises a pool of questions attached to different departments. The system administrator is able to set the % of questions from each department and the total number of questions the test should contain (as well as any other options listed above). The system or application program then randomly selects questions in the proportion (%) entered each time the test is taken. The test pass point can be set and the user can be forced to take the test over and over till they pass, each time receiving a new random set of questions.

Case Study (CS) Section (360): The CS system is designed to lend flexibility to workflow (WF). A flexible workflow allows for both oddities and standard cases in medicine to be reproduced. The grading is designed to work within a framework to promote regularity between CS and CS designers. Such a predefined framework allows for more accurate reporting and maintains a level of consistency throughout. While a CS is being created, the responsible physician enters descriptions of why diagnoses and examination options are useful or not. Such information aids the student during the review portion of the CS.

The CS workflow and review are designed to compel the student to think about the process required in properly evaluating a patient not necessarily teaching the disease or its treatment. However the student may be requested to suggest a treatment. This proper evaluation process is the heart of the teaching the system is designed to impart on the student. Essentially, this limitation makes sure the student learns the evaluation process correctly, and does not merely accidentally achieve a correct diagnosis with incorrect reasoning.

The educational process imparted by the system or application program may be described as for separate parts. The first is the work flow of the CS. The next is the grading of the CS, the third is the review of the CS by the physician and the fourth is the review of the CS by the student.

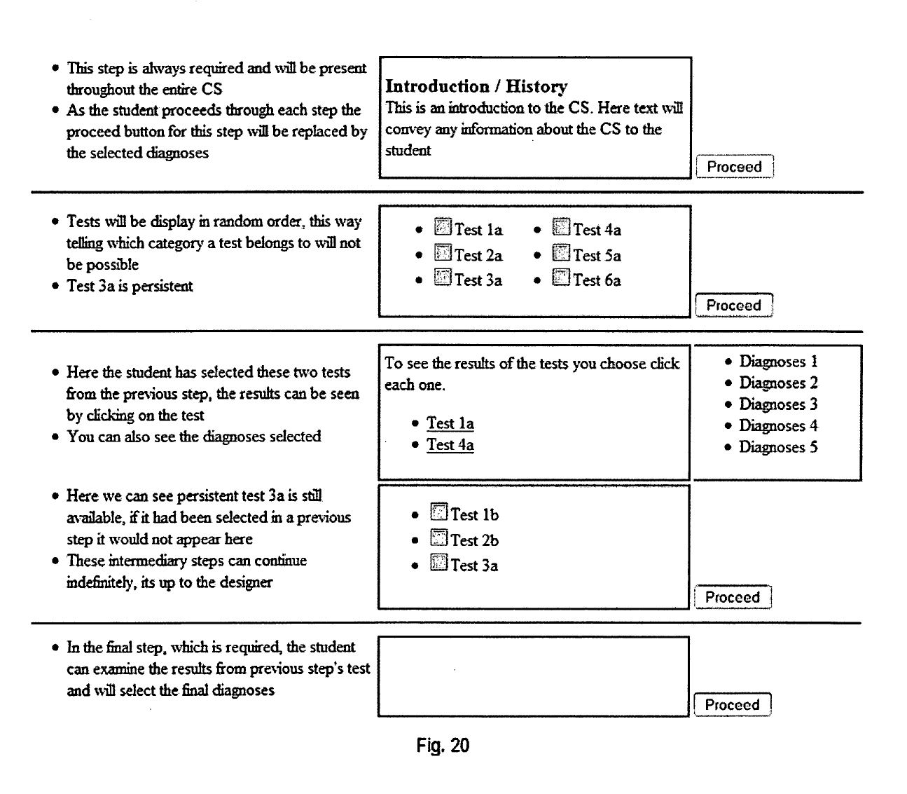

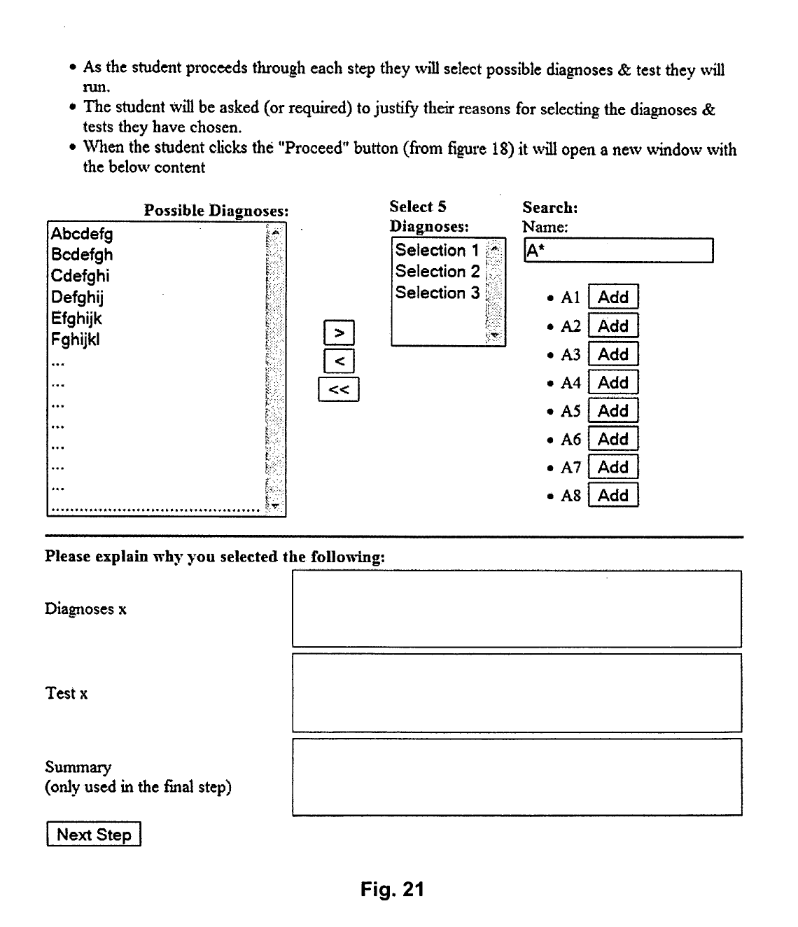

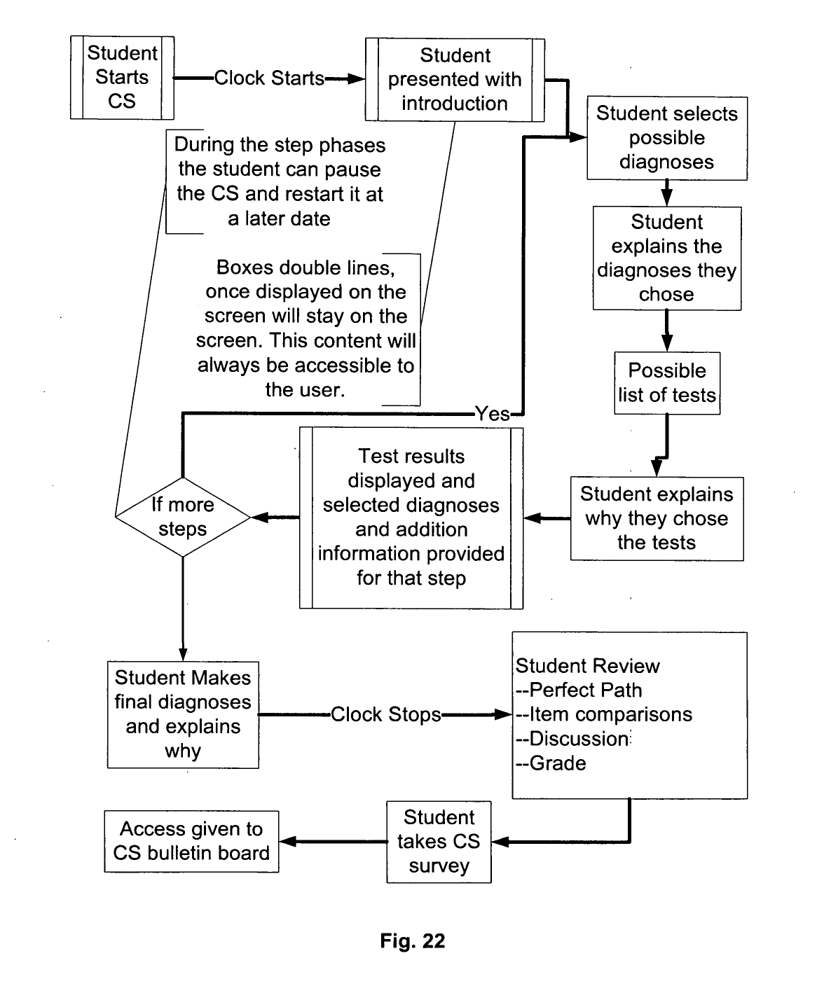

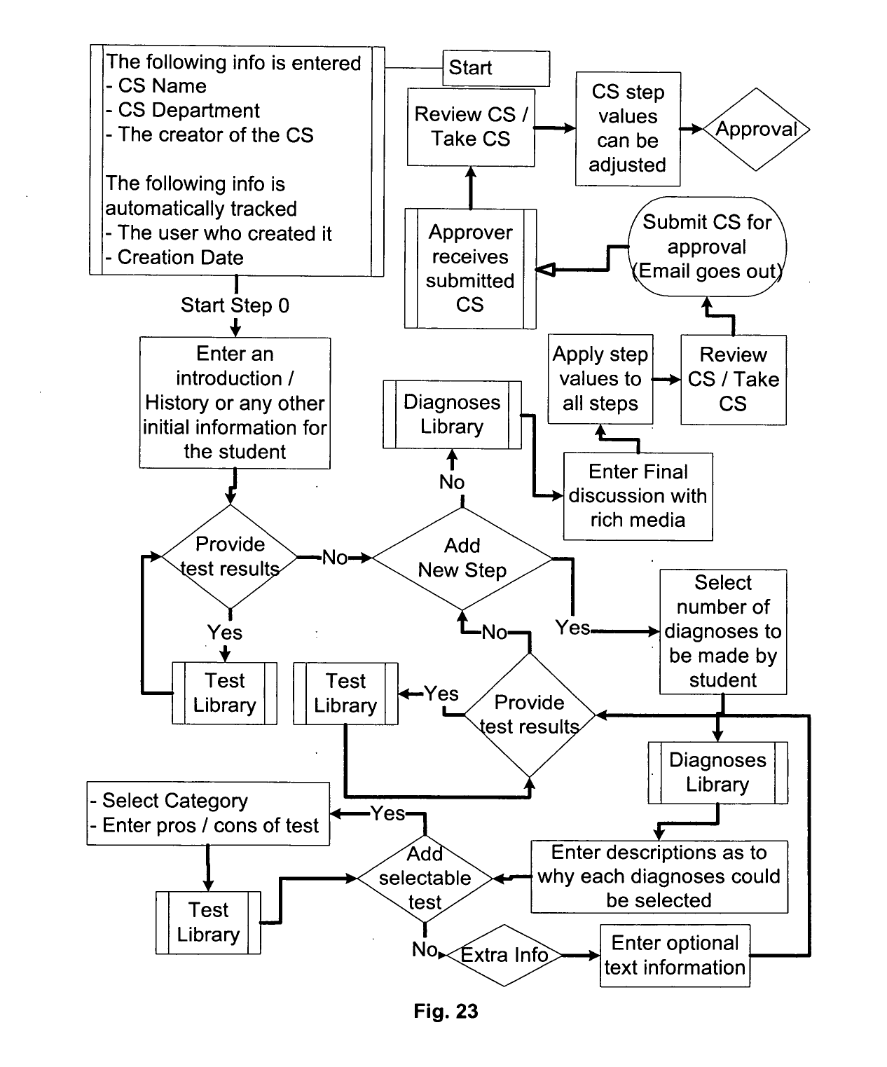

Work flow: The anatomy of a case study (CS) contains three parts, which are presented to the student in three steps, as set forth in detail in the flow charts of FIGS. 22 and 23. These are the Introduction/History, Examination Option Steps (EOS) and the Final Diagnosis (FD), as shown in FIG. 20. The Introduction/History and FD are mandatory, where EOS are optional. As such, when referring to the number of parts in a CS, the number of EOS are what is specifically referred to. When a CS is presented to a student, the Introduction/History is always the initial step. The introduction/History contains any material the CS designer deems appropriate, for example, symptoms, history, previously run test results, etc.

After being presented with the Introduction information, the CS then moves on to the EOS. The number of EOS the designer inputs is variable, zero is acceptable. Each CS step presents the student with the first component of each CS-step requires the student to rank/re-rank their top “X” diagnoses. “X” can change as the steps proceed. As in all other decision processes, the student will be asked to explain their rational each time they make choices. Then more introduction information and/or examination options (i.e. procedures, tests, etc.). The student then chooses which examination option(s) they wish to perform.

The student is then asked to explain, i.e., respond, to support their decision as to why they have chosen these examination options. The results of the examination options are then returned to the student for evaluation. This continues as long as the CS has EOS. When all EOS are complete the student moves to the FD. After the final diagnosis is made, the student may be requested to enter proper notation as to why the tests were run from the point of view of billing insurance companies to maximize reimbursement from the insurance companies. The system may even show optional tests that can replace the selected test that are more cost effective hence increasing revenues for the hospital. Finally the review process begins.

Examination options can be persistent or non-persistent. Persistent examination options, once offered, will continue to be offered until selected or the CS ends. The student is not made aware of this. This is a useful option for the creator of the CS. Non-persistent procedures are only offered in the given step.

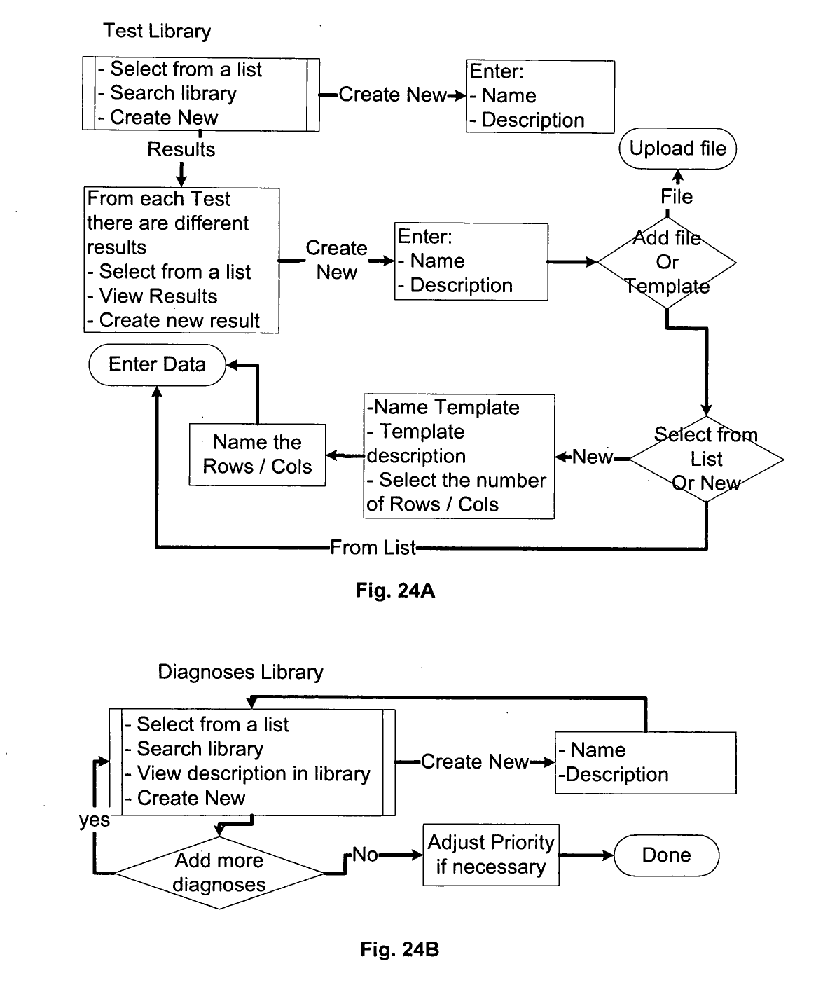

Two libraries are built for use with this system, for example, contained in database (120). One library is populated with examination options (i.e., tests) and their results (FIG. 24A), and the other with diagnoses (FIG. 24B). As CS are entered into the system, all diagnoses and examination options are saved in the system for reuse. As such, when entering the first CS, the libraries are typically empty. As more CS are entered, the libraries grow and the extreme usefulness and time savings of the libraries becomes evident. Libraries display as lists.

The lists can be searched and viewed to make certain the item is what the CS designer needs. Diagnoses are names and short descriptions. Examination options are either a template or rich media content. The system ability to create new entries in the diagnosis library and the ability to create new templates in the test library is privilege based. Additionally, the system includes a delete functionality in the diagnoses library that operates a clean up tool. As such, the system makes it possible for users to keep the library clean.

The system provides that a student can, at anytime pause the CS and complete it at a later time. But the system, while configured to enable this option, may configure it such that a CS not completed in 96 hours will automatically expire. The overall process of taking the CS is timed for tracking purposes. For that matter, an average time to complete a CS may be displayed before the student starts the CS.

A student may take a given CS multiple times, by each score for each time is recorded. Questionnaire that are presented as part of the review process, however, are only available the first time the student completes the CS.

With respect to grading, the system has built in a variety of elements to ensure flexibility. That is, the system grading is flexible and enables great discretion by the creator of the CS. First the creator sets the percent required to pass the CS. For example, a score above 75% is passing, below is failing. Next the creator sets the percent value of each step, or step value (SV). At this point. The CS has been fully entered into the system, so all steps are easily visible. All the steps values must add up to 100%.

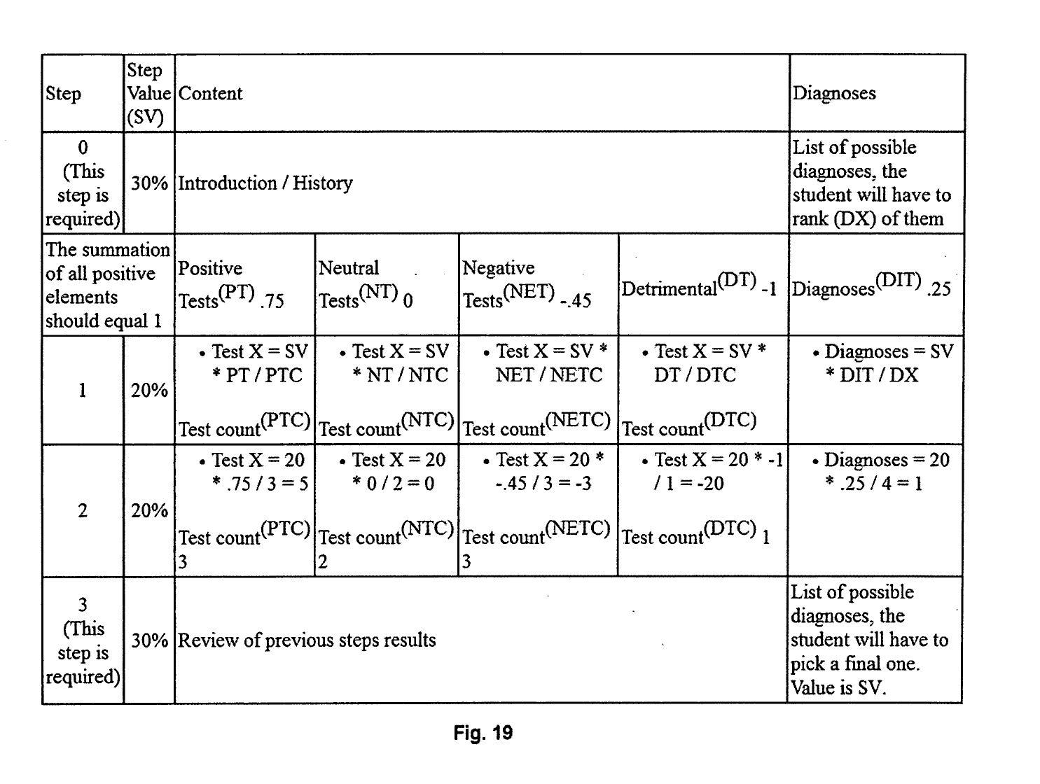

As is apparent from a careful reading of FIG. 19, there are two opportunities for the SV to be set, once by the creator and once by the approver. In a three step CS, the designer/physician enters five percents adding up to 100%. For example, 20% could be assigned per C-Step, 30% for the Introduction and 10% for the FD. Moreover, in each step, the Physician (or person entering the CS) will set the examination options to be in one of the following categories: Correct, Neutral, Incorrect or Detrimental.

Each category is worth “X” of that given step's value (PT, NT, NET, DT, DIT). The category values are set by the administrator. All the positive variables (PT, DIT) must add up to 1. As should be apparent by the FIG. 19 formulas, the highest score achievable is 100%. The reader should note that it is possible for a student to receive a negative score. The counts represent the number of examination options for a given step in a given category (*C). For persistent examination options, if the examination option is selected it will be added to *C. If it is not selected then it will not be counted until the final C-Step.

Reports section (370): The system and application program tracks many data points that may be “mined” from the system, some of which may useful to the student's learning process. That is, the reports function allows privileged users to query the database. The users can choose the data points to display in the report the order the data points, any sorting, any filters they choose such as date ranges, and the format by which they receive the report (text or CSV). This flexibility allows you to create the reports you need when you need them.

Assessments section (380): This section includes the physician's review. The physician's review begins to take form, or is configured as he/she creates the CS. When entering the examination options, the system requires that the physician explain why correct choices are correct. An additional option requires the physician to explain why incorrect choices are such. The same logic applies to a diagnosis. An overall discussion of the CS (which can contain rich media) is the final review element entered into the system. These items complete the student review and create enormous efficiencies in developing a comprehensive, automated review for the student.

Once the student has completed the CS, the physician has the option of reviewing each of the steps, choices and explanations provided by the student. This allows the physician the opportunity to personalize responses if necessary. Physicians can respond by attaching comments to that CS for the student to review. The student and physician can converse on a private bulletin board about the CS in an on-line session. Moreover, the student and physician can speak if necessary, for example, using VoIP technology.

During the student review, the student is presented with and interactively completes questions (i.e., responses) of a questionnaire relating to the CS just taken. The questionnaire, along with the CS specific bulletin board with the student responses provides the institution with valuable feedback for each CS.

Treatments section (390)—The treatments sections includes that after the final diagnosis is made, the student may be requested to suggest possible treatments for the disease. This helps train in many ways. For example, as new physicians do not receive training on how to fill out the insurance forms for the tests they run, such lack of training generally creates lots of extra paper work for the hospital. This function provides training to teach physicians a correct way to fill this out insurance forms, for example, asking them to choose from a list of possible reasons and then show them the correct response. The section or function also displays optional tests with respect to a student-selected test, which shows the student the other test s that might provide realize same information that is elicited from the student chosen test, and might be more economical for the hospital.

Student Review: Once the student has completed the CS, the system reveals the “perfect path” to the diagnosis. All the positive examination options, with the Physician's explanations, are compared to the student's choices with their explanations. In this format, all the positive categorized examination options are shown as the perfect path. Examination options that the student chose, which are not positive, are pointed out. If the physician filled in the pros and cons for the non positive examination options, this too will be displayed. The Physician's final discussion will be displayed below the examination options comparison. The student at anytime, even after leaving the CS, can come back and review section.

Next, the student is required to complete a questionnaire about the CS. Once the questionnaire is submitted the student's grade is revealed and they gain access to the bulletin board specific to that CS.

Billing Forms and Test Optimization section (400). This section or function allows the user to enter into the billing form training which trains students to properly fill out medical billing forms to maximize reimbursement from insurance companies, and for offering substitute tests that are more cost effective.

This system is database driven. As the user moves around the different section or functions, a help link at the bottom of particular pages is available to link the user to the appropriate help documentation. In addition, the user is able to search the database for other topics. Access to the help documents is controlled in the same way module access is controlled. Actual help documentation is written once the application is completed configured to an institution's rules.

Although examples of the present invention have been shown and described, it would be appreciated by those skilled in the art that changes may be made in these embodiments without departing from the principles and spirit of the invention, the scope of which is defined in the following claims and their equivalents.

What is claimed is:

1. A medical diagnostics training system that presents a sequence of interactive display images comprising a medical diagnostics case study (CS) to a student including challenges or tests to which the student responds to qualify his/her competency in a diagnostics technique and required critical thinking to be imparted by the case study (CS), collecting and processing the student responses to determine the competency in the technique and critical thinking and providing a review process and directed feedback from a physician in the diagnostics technique pursuant to the review process where necessary to improve the student critical thinking and competency therein, comprising:
a computer processor for implementing system communication processes, interactive users interface processes, training workflow processes and medical diagnostics case study (CS) configuring processes; and
a database for receiving and storing data comprising the medical diagnostics case study (CS) data, challenge or test data, student data including student responses to the challenges or tests, physician data, administrative data, Daemon data, treatments data, reports, and pages or templates defining various display images for presentation during system operation;
wherein for each case study (CS), the challenges or tests and directed feedback correlated to a student's responses to the challenges or tests operate to develop the student's critical thinking and to master the particular diagnostics technique meant to be imparted by the case study (CS).

2. The medical diagnostics training system as set forth in claim 1, wherein said communication processes control electronic communications with any of student, physician and administrator data processing systems.

3. The medical diagnostics training system as set forth in claim 2, wherein said computer processor comprises a server, wherein any of said student, physician and administrator data processing systems comprise a browser and wherein said communication processes implement and control said communication processes over a network using HTML and CGI protocol.

4. The medical diagnostics training system as set forth in claim 3, wherein said communication processes further control electronic communications and messaging exchanges between any of said student, physician and administrator data processing systems, where necessary.

5. The medical diagnostics training system as set forth in claim 1, wherein said interactive users interface processes cooperate with said communication processes to present said interactive display images comprising said medical diagnostics case study (CS) including simulations and challenge data, to collect and transfer student responses to said challenge data to said computer processor and/or said database and to process and review the responses in order to generate and direct feedback to hone the student's critical thinking in accordance therewith.

6. The medical diagnostics training system as set forth in claim 5, wherein said training workflow processes control a workflow for controlling said interactive users interface processes and said communication processes.

7. The medical diagnostics training system as set forth in claim 1, wherein said case study (CS) configuring processes cooperate with said communication processes to receive data for configuring the system, including data for defining and controlling the training workflow processes.

8. The medical diagnostics training system as set forth in claim 7, further comprising a rules engine, wherein said medical diagnostics case study (CS) configuring processes define rules for the rules engine and wherein the rules engine controls said training workflow processes.

9. The medical diagnostics training system as set forth in claim 8, wherein said rules engine cooperates with at least one of an administration function and a daemon function.

10. The medical diagnostics training system as set forth in claim 9, wherein said rules engine, said administration function and said daemon function are preconfigured by institutional administrators prior to intended system operation.
